(19) United States
(12) Patent Application Publication
(10) Pub. No.: US 2015/0218302 A1
(43) Pub. Date: Aug. 6, 2015

(54) THERMALLY STABLE RIGID FOAMS AND METHODS OF MAKING SAME

(71) Applicant: ATLAS ROOFING CORPORATION, Meridian, MS (US)

(72) Inventors: Joseph Sennett Conner BRADY, III, Laurel, MS (US); Darrell THOMPSON, Meridian, MS (US)

(21) Appl. No.: 14/613,120

(22) Filed: Feb. 3, 2015

Related U.S. Application Data
(60) Provisional application No. 61/935,401, filed on Feb. 4, 2014.

(51) Int. Cl. C08G 18/74; C08G 18/32; C08G 18/08

(52) U.S. Cl. CPC C08G 18/74; C08G 18/14; C08G 18/3203; C08G 2101/0025

(57) ABSTRACT

The presently disclosed technology provides a composition and method for producing a thermally stable, rigid polyurethane and/or polyisocyanurate foam by reducing or eliminating the presence of alkali metal components and/or alkali earth metal components, thereby producing a foam, which under fire conditions, will at least maintain its volume or intumesce or not reduce its volume by more than about 30%. The presently disclosed technology allows for a reduction in alkali and/or alkali earth metal components in foams that meet current standards with reduced fire retardant loadings. The presently disclosed technology further provides foams with lower alkali and/or alkali earth metal components which may be made to increase in volume under fire conditions.

The present application claims benefit of U.S. Provisional Application No. 61/935,401 filed Feb. 4, 2014, the entire contents of which is incorporated herein by reference.

The presently disclosed technology provides a composition and method for producing a thermally stable, rigid polyurethane and/or polyisocyanurate foam by reducing or eliminating the presence of alkali metal components and/or alkali earth metal components, thereby producing a foam, which under fire conditions, will at least maintain its volume or intumesce or not reduce its volume by more than about 30%. The presently disclosed technology allows for a reduction in alkali and/or alkali earth metal components in foams that meet current standards with reduced fire retardant loadings. The presently disclosed technology further provides foams with lower alkali and/or alkali earth metal components which may be made to increase in volume under fire conditions.

### BACKGROUND

Polyisocyanurate foam is currently the most cost effective insulation available. Rigid polyisocyanurate foam is known as the industry leader in producing both R-value and burn performance. These type foams can be used in refrigeration, freezers, hot water systems, sandwich panels, construction panels for roofs, walls, ceilings and floors, as well as spray in place foam for insulation and sealing.

In recent years, many flame retardants used the industry have been criticized by environmental groups as negatively effecting the environment and the health of humans and animals. In 2003, California legislation imposed a statewide ban on polybrominated diphenyl ethers (PBDEs) as well as other types of halogenated organo-phosphorus flame retardants due to their environmental impact. Also, in 2009, the Canadian government's Proposed Risk Assessment Approach for Tris(2-chloroethyl)phosphate (TCEP) was published which banned its use in Canada. TCEP is also banned in Europe. Tri(2-chloro-1-methylethyl)phosphate (TCPP) is one of the most commonly used flame retardants in the industry today. The European Risk Assessment for TCPP, which was published in 2008, concluded that currently no need exists for “further information and/or testing and no need for risk reduction measures beyond those which are being applied already” with regard to human health. However, recent studies have found the presence of TCPP in household dust, aquatic life and breast milk. This has led to many publications which suggest the need for the industry to remove these potentially hazardous materials from products. There are flame retardants available in the market today that are not currently listed as being hazardous, many of which are non-halogenated. However, under current market conditions, these non-halogenated flame retardants are not economically viable. Therefore, there currently exists in the industry a need for an economically viable solution that results in the reduction or elimination of at least halogenated flame retardants. A reduction or elimination of flame retardants in general is also believed to be beneficial.

### SUMMARY

The presently disclosed technology provides a composition and method that will reduce the amount of flame retardant required to meet the current flammability standards. The presently disclosed technology further provides compositions and methods to exceed current flammability standards by producing foams with a reduced loss in volume or even an increase in volume under fire conditions. Since its inception, polyisocyanurate foam producers have used potassium salt catalysts to promote trimerization. These potassium salts of carboxylic acids, such as potassium acetate and potassium octoate, have been used because they are efficient, economical and readily available. In recent years other trimerization catalysts have been developed which do not contain potassium or other alkali metals, however until the present disclosure, these catalysts have proven to be economically unviable.

U.S. Patent Applications 2014/0094530 and 2014/0066532 describe rigid foams with improved thermal stability. However, their claims combine the use of methyl formate (MF) and non-halogenated flame retardants and are application specific. The use of MF is not desirable due to its tendency to contaminate manufacturing equipment. Furthermore, the use of MF would require additional equipment for storage and transfer. MF also acts as a solvent in polyurethane and polyisocyanurate systems, which could lead to reduced compressive strength and an increased risk of edge collapse or other dimensional stability issues. Also, the formulations listed in this application use higher concentrations of water, which negatively impacts the performance of the product by increasing friability and reducing R-value. These high water formulas are also more prone to shrinkage during processing and typically increase cost due to the increased amount of isocyanate required to obtain the desired index. The presently disclosed technology does not require methyl formate. Moreover, the applications do not disclose or suggest the advantages described herein that can be achieved by limiting or reducing the amounts of alkali and/or alkali earth metals in the foam formulations.

U.S. Patent Application 2009/0156704 and U.S. Pat. No. 8,916,620 B2 claim the use of non-halogenated flame retardants in polyurethane foam. However, their claims are related to the use of specific flame retardants and not the catalyst system used to make them economically viable. Furthermore, the flame retardants listed exist as solids which are currently difficult to use in manufacturing facilities. The presently disclosed technology that provides improved thermal stability of foams while also making it possible to reduce the quantity of flame retardant is not described or suggested in U.S. Patent Application 2009/0156704 and U.S. Pat. No. 8,916,620 B2.

U.S. Patent Application 2014/0042361 and U.S. Pat. Nos. 8,779,018 and 8,580,864 B2 claim the use of catalysts which may or may not contain alkali or alkali earth metals. However, their claims are specific to processability and catalyst composition and do not describe or suggest the advantages of the presently disclosed technology. Furthermore, the presently disclosed technology provides improvements in affordability and performance with commercially available catalyst.

There still exists a need to make affordable and environmentally compatible foam products as described herein. The presently disclosed technology fulfills that need. It does so, for example, by reducing the amount of costly and potentially harmful flame retardants required to meet building codes. This reduction also removes several processing hurdles encountered in manufacturing. The reduction in flame retardant improves processability by reducing the amount of solids required to manufacture a product that uses solids and meets fire codes, it also negates the need for blowing agents such as MF which is troublesome at best. The presently disclosed technology also allows for the reduction of currently used halogenated flame retardants by increasing their efficiency. Furthermore, the presently disclosed technology provides a means to improve the efficiency of all flame retardants known in the art. As described and demonstrated herein, thermal stability of foams of the presently disclosed technology is only partially related to the type of flame retardant used and is more directly related to the reduction or lack of alkali and/or alkali earth metal present in the final product.

The present inventors have discovered that the potassium and other alkali metal and/or alkali earth metal containing catalysts commonly used in foam formulations, negatively impact the thermal stability of foam under fire conditions. The presently disclosed technology provides compositions and methods for producing a polyisocyanurate foam containing a non-reactive flame retardant and/or a flame retardant component that is reacted into the polymer matrix and a catalyst other than an alkali metal and/or alkali earth metal containing catalyst. The catalyst system may alternatively be a system which reduces the overall amount of alkali metal and/or alkali earth metal as compared to systems known and/or used in the art. This reduction and/or elimination in alkali and/or alkali earth metal improves the efficiency of the flame retardant component. This, in turn, provides a pathway for the reduction in the amount of the flame retardant component required to meet current flammability standards. The presently disclosed technology further provides compositions and methods for producing foams with increased expansion performance under fire conditions as compared with existing formulations. Such increased expansion may be produced by using current or increased amounts of flame retardant with decreased amounts of alkali and/or alkali earth metal components.

### BRIEF DESCRIPTION OF FIGURES

FIG. 1. Demonstrates results of the example of Table 1 wherein Formula 1 of Table 1 (Control of FIG. 1), Formula 2 of Table 1 (Formula 1 of FIG. 1) and Formula 3 of Table 1 (Formula 2 of FIG. 1).

FIG. 2. Graphical representation of the percent volume increase of compositions of formulas 1, 2 and 3 of the example of Table 1.

FIG. 3. Graphical representation of the percent volume increase of compositions of formulas 1 (infinity), 2 (11.5:1), 3 (5.5:1), 4 (4:1) and 5 (3:1) of the examples of Table 2.

FIG. 4. Graphical representation of the percent volume increase of compositions of formulas 1 (0 ppm K by weight), 2 (500 ppm K by weight), 3 (1000 ppm K by weight), 4 (1500 ppm K by weight), and 5 (1880 ppm K by weight) of the examples of Table 2.

FIG. 5. Graphical representation of percent volume increase of compositions of the formulas 1 (Phosphorus:Alkali Mole Ratio of 3.5:1), 2 (Phosphorus:Alkali Mole Ratio of 2.0:1) and 3 (Phosphorus:Alkali Mole Ratio of 1:1) of the examples of Table 3.

FIG. 6. Top view of samples of compositions of the formulas 1 (Phosphorus:Alkali Mole Ratio of 3.5:1), 2 (Phosphorus:Alkali Mole Ratio of 2.0:1) and 1 (Phosphorus:Alkali Mole Ratio of 1:1) of the examples of Table 3.

FIG. 7. Graphical representation of percent volume increase of compositions of the formulas 1 (153 moles of phosphorus per million grams of foam), 2 (80 moles of phosphorus per million grams of foam), 3 (41 moles of phosphorus per million grams of foam), 4 (17 moles of phosphorus per million grams of foam), 5 (8 moles of phosphorus per million grams of foam), and 6 (4 moles of phosphorus per million grams of foam) of the examples of Table 4.

FIG. 8A. Top view photo of compositions of the formulas 1 (153 moles of phosphorus per million grams of foam), 2 (80 moles of phosphorus per million grams of foam), 3 (41 moles of phosphorus per million grams of foam), 4 (17 moles of phosphorus per million grams of foam), 5 (8 moles of phosphorus per million grams of foam), and 6 (4 moles of phosphorus per million grams of foam) of examples of Table 4.

FIG. 8B. Perspective view photo of compositions of the formulas 1 (153 moles of phosphorus per million grams of foam), 2 (80 moles of phosphorus per million grams of foam), 3 (41 moles of phosphorus per million grams of foam), 4 (17 moles of phosphorus per million grams of foam), 5 (8 moles of phosphorus per million grams of foam), and 6 (4 moles of phosphorus per million grams of foam) of examples of Table 4.

FIG. 9. Graphical representation of percent volume increase of compositions of the formulas 1 (phosphorous:alkali molar ratio of 4.5:1), 2 (phosphorous:alkali molar ratio of 3:1), 3 (phosphorous:alkali molar ratio of 1.5:1), and 4 (phosphorous:alkali molar ratio of 0:1) of the examples of Table 5.

FIG. 10A. Top view photo of compositions of the formulas 1 (phosphorous:alkali molar ratio of 4.5:1), 2 (phosphorous:alkali molar ratio of 3:1), 3 (phosphorous:alkali molar ratio of 1.5:1), and 4 (phosphorous:alkali molar ratio of 0:1) of the examples of Table 5.

FIG. 10B. Perspective view photo of compositions of the formulas 1 (phosphorous:alkali molar ratio of 4.5:1), 2 (phosphorous:alkali molar ratio of 3:1), 3 (phosphorous:alkali molar ratio of 1.5:1), and 4 (phosphorous:alkali molar ratio of 0:1) of the examples of Table 5.

FIG. 11. Graphical representation of percent volume increase of compositions of the formulas 1 (219 moles of phosphorous per million grams of foam), 2 (148 moles of phosphorous per million grams of foam), 3 (75 moles of phosphorous per million grams of foam), and 4 (0 moles of phosphorous per million grams of foam) of the examples of Table 6.

FIG. 12A. Top view photo of compositions of the formulas 1 (219 moles of phosphorous per million grams of foam, 2 (148 moles of phosphorous per million grams of foam), 3 (75 moles of phosphorous per million grams of foam), and 4 (0 moles of phosphorous per million grams of foam) of the examples of Table 6.

FIG. 12B. Perspective view photo of compositions of the formulas 1 (219 moles of phosphorous per million grams of foam), 2 (148 moles of phosphorous per million grams of foam), 3 (75 moles of phosphorous per million grams of foam), and 4 (0 moles of phosphorous per million grams of foam) of the examples of Table 6.

FIG. 13. Graphical representation of percent volume increase of compositions of the formulas 1 (bromine:alkali molar ratio of 9:1), 2 (bromine:alkali molar ratio of 6:1), 3 (bromine:alkali molar ratio of 4.5:1), 4 (bromine:alkali molar ratio of 3:1), 5 (bromine:alkali molar ratio of 1.5:1) and 6 (bromine:alkali molar ratio of 0:1) of the examples of Table 7.

FIG. 14A. Top view photo of compositions of the formulas 1 (bromine:alkali molar ratio of 9:1), 2 (bromine:alkali molar ratio of 6:1), 3 (bromine:alkali molar ratio of 4.5:1), 4 (bromine:alkali molar ratio of 3:1), 5 (bromine:alkali molar ratio of 1.5:1) and 6 (bromine:alkali molar ratio of 0:1) of the examples of Table 7.

FIG. 14B. Perspective view photo of compositions of the formulas 1 (bromine:alkali molar ratio of 9:1), 2 (bromine:alkali molar ratio of 6:1), 3 (bromine:alkali molar ratio of 4.5:1), 4 (bromine:alkali molar ratio of 3:1), 5 (bromine:alkali molar ratio of 1.5:1) and 6 (bromine:alkali molar ratio of 0:1) of the examples of Table 7.

FIG. 15. Graphical representation of percent volume increase of compositions of the formulas 1 (210 moles of bromine per million grams of foam), 2 (146 moles of bromine per million grams of foam), 3 (76 moles of bromine per million grams of foam), and 4 (0 moles of bromine per million grams of foam) of the examples of Table 8.

FIG. 16A. Top view photo of compositions of the formulas 1 (210 moles of bromine per million grams of foam), 2 (146 moles of bromine per million grams of foam), 3 (76 moles of bromine per million grams of foam), and 4 (0 moles of bromine per million grams of foam) of the examples of Table 8.

FIG. 16B. Perspective view photo of compositions of the formulas 1 (210 moles of bromine per million grams of foam), 2 (146 moles of bromine per million grams of foam), 3 (76 moles of bromine per million grams of foam), and 4 (0 moles of bromine per million grams of foam) of the examples of Table 8.

FIG. 17. Shows the basic structure and process steps according to an example laminator including inputs of polyester polyol (140), catalysts (150), surfactants (160), blowing agents (170), optional flame retardant (180) in to a mixing tank (190), polymeric polyisocyanate (200), mixing device (210), bottom facer roll (110), top facer roll (120), foamed product (130), laminator top belt (220), laminator bottom belt (230), laminator (100), cross-cut saw (240), laminated foam boards (250₁ and 250₂) and transfer conveyor (260).

### DETAILED DESCRIPTION

It has unexpectedly been found that a polyisocyanurate foam composition with reduced amounts of alkali metal and/or alkali earth metal to levels at or below 2000-ppm (by weight) or alternatively below 1800 ppm, or below 1600 ppm or alternatively below 1500 ppm, or below 1000 ppm, or below 500 ppm or below detectable limits, such as when analyzed by ICP/MS in accordance with EPA method 200.8 (the entire contents of which is incorporated herein by reference), advantageously has improved thermal stability under fire conditions and/or high temperature. It was discovered that reducing the alkali content of the formulation produced a thermally stable foam which maintained its volume (i.e., maintained a volume of at least 70% of the original volume under fire testing conditions) or intumesced under fire conditions and/or high temperature environments. It was also discovered that the amount of intumescence was directly related to the molar ratio of flame retardant component and the alkali metal and/or alkali earth metal.

As described and demonstrated herein, formulations containing less alkali metal and/or alkali earth metal produced foams which exhibited greater intumescence under fire conditions and/or high temperature with a similar amount of flame retardant, and that foams with similar intumescence or similar loss in volume under fire conditions and/or high temperature could be produced with lower levels or amounts of flame retardant by decreasing or eliminating (as determined to be below detectable levels by, for example, ICP/MS in accordance with EPA method 200.8) the amount of alkali metal and/or alkali earth metal.

While not wishing to be bound to or being required to provide any theoretical explanation for the presently disclosed surprising effect, it is believed that the presence of alkali and/or alkali earth metal neutralizes the chemical by product formed by the decomposition of the flame retardant at elevated temperature. The reduction or elimination of alkali and/or alkali earth metal allows the decomposition product of the flame retardant to better serve its function related to thermal stability of the polymer matrix at elevated temperature. The phosphorus, sulfur, and halogens commonly and often preferably used in foam compositions produce acids which act as char forming catalyst at elevated temperature. Alkali and alkali earth metals are believed to produce strong bases at elevated temperature. The bases formed at elevated temperature may then neutralize the acids, forming temperature stable salts. Once the salt is formed these compounds no longer contribute to the thermal stability of the polymer matrix. The presently disclosed technology is believed to possibly reduce or eliminate formation of the salts and thereby allow for more efficient use of the char forming catalyst at elevated temperature.

The presently disclosed technology is demonstrated and exemplified by the following non-limiting description and examples. All composition amounts are described herein in terms of percent total foam unless otherwise indicated.

Compositions of the presently described technology advantageously include:

a) At least one isocyanate reactive polyether or polyester polyol with a functionality of 1.8 or greater

b) At least one cell stabilizing surfactant

c) At least one amine catalyst

d) At least one trimerization catalyst which does not contain alkali metals or alkali earth metals

e) At least one blowing agent such as n-pentane, isopentane, cyclopentane or any combination thereof and water

f) At least one organic polyisocyanate

g) At least one flame retardant component, which may be reactive and/or non-reactive.

The compositions described herein produce foams having a density range of 1.5 pounds per cubic foot (pcf) to 5 pcf, such as in the range of 1.5 pcf to 5 pcf, or 1.5 pcf to 4.5 pcf, or 1.5 pcf to 4.0 pcf, or 1.5 pcf to 3.5 pcf, or 1.5 pcf to 3.0 pcf, or 1.5 pcf to 2.5 pcf, or 1.5 pcf to 2.0 pcf, or 1.6 pcf to 5 pcf, or 1.6 pcf to 5.5 pcf, or 1.6 pcf to 4.5 pcf, or 1.6 pcf to 4.0 pcf, or 1.6 pcf to 3.5 pcf, or 1.6 pcf to 3.0 pcf, or 1.6 pcf to 2.5 pcf, or 1.6 pcf to 2.0 pcf, or 1.7 pcf to 5 pcf, or 1.7 pcf to 5.5 pcf, or 1.7 pcf to 4.5 pcf, or 1.7 pcf to 4.0 pcf, or 1.7 pcf to 3.5 pcf, or 1.7 pcf to 3.0 pcf, or 1.7 pcf to 2.5 pcf, or 1.7 pcf to 2.0 pcf.

The foam forming formulation contains at least one organic compound containing at least 1.8 or more isocyanate reactive groups per molecule. Isocyanate reactive compounds according to the present disclosure include polyester and polyether polyols, including mannich based polyols. The polyester polyols useful in the present disclosure can be prepared by known procedures from a polycarboxylic acid or acid derivative, such as an anhydride or ester of the polycarboxylic acid and a polyhydric alcohol. Although the polyester polyol may be aliphatic, cycloaliphatic or aromatic, the aromatic polyols are typically preferred due to their higher thermal stability. Polyether polyols useful according to the presently disclosed technology include reaction products of a polyfunctional active hydrogen initiator and a monomeric unit such as ethylene oxide, propylene oxide, butylene oxide and mixtures thereof, preferable propylene oxide, ethylene oxide or mixed propylene oxide and ethylene oxide. The functionality of the preferred polyols described in the invention is typically between 2.0 and 8.0, with hydroxyl numbers between 25-mg KOH/gm and 1000-mg KOH/gm. The most preferred polyols described in the invention have functionalities that are typically between 2.0 and 3.0 with hydroxyl numbers between 150-mg KOH/gm and 400-mg KOH/gm. These polyols are commercially available as Stepanpol polyols from Stepan Company and Terate polyols from Invista.

Surfactants, emulsifiers, and/or solubilizers may also be employed in the production of polyisocyanurate foams of the present disclosure in order to increase the compatibility of the blowing agents with the isocyanate and polyol components. Surfactants may serve two purposes. First, they may help to emulsify/solubilize all the components so that they react completely. Second, they may promote cell nucleation and cell stabilization. Exemplary surfactants include silicone co-polymers or organic polymers bonded to a silicone polymer. Although surfactants can serve both functions, a more cost effective method to ensure emulsification/solubilization may be to use enough emulsifiers/solubilizers to maintain emulsification/solubilization and a minimal amount of the surfactant to obtain good cell nucleation and cell stabilization. Examples of surfactants include Pelron surfactant 9900, Goldschmidt surfactant B8522, and GE 6912. U.S. Pat. Nos. 5,686,499 and 5,837,742 are incorporated herein by reference with regard to useful surfactants. Suitable emulsifiers/solubilizers include DABCO Kitane 20AS (Air Products), and Tergitol NP-9 (nonylphenol+9 moles ethylene oxide).

Amine catalyst may be used in the presently disclosed technology to promote the reaction of the water with the isocyanate. This reaction produces carbon dioxide which acts as a co-blowing agent and helps initiate the polyurethane reaction. Amine catalyst can include Polycat 5 from Air Products and ZF-20 from Huntsman.

Traditional polymerization and trimerization catalysts and catalyst combinations have included salts of alkali metals and/or alkaline earth metals, and carboxylic acids or phenols, such as, potassium octoate or potassium acetate, and sodium hydroxyl-nonylphenyl-N-methylglycinate (Curethane 52). However, the formulations of the presently disclosed technology include little if any alkali metal salt or alkaline earth metal salt catalysts, as it has been discovered that the traditionally used alkali metal salt and/or alkaline earth metal salt containing catalysts reduce the effectiveness of fire retardants, such as phosphorus-, sulfur- and/or halogen-containing fire retardants. Examples of the catalysts used in the presently disclosed technology include tertiary amines, such as tetramethylhexadiamine (TMHDA). Useful catalysts may include TEDA L-33 (dipropylene glycol solution of triethylenediamine), TOYOCAT-MR (Pentamethyldiethylenetriamine (PMDETA)), -DT (PMDETA-N,N,N′,N″,N″-Pentamethyldiethylenetriamine), -NP(N,N′,N′-Trimethylaminoethylpiperazine), -ET (70% bis(2-dimethylaminoethyl)ether solution in dipropylene glycol) or -ET-S available from Tosoh. Polycat 17 (N,N,N′-Trimethyl-N′-(hydroxyethyl)-1,3-propanediamine) or 41 (3-[3,5-bis[3-(dimethylamino)propyl]-1,3,5-triazinan-1-yl]-N,N-dimethylpropan-1-amine), Dabco-33 LVC (dipropylene glycol solution of ethylenediamine), Dabco-T or Dabco-TMR, TMR-2 (2-hydroxypropyl)trimethylammonium formate, DMP-10 (dimethylamino) methyl phenol, TMR-30 (2,4,6-tris(dimethylaminomethyl)phenol), TMR-7, available from Air Products, dibutyltin dilaurate, and stannous octoate available from Yoshitomi. These catalysts may be used individually or in combination. The amount of catalysts used in the presently disclosed technology may be in an amount of less than 5.0% by weight of the total foam weight, alternatively between 0.5-3.0% by weight and further alternatively between 0.5-2.0% by weight of the total foam weight.

Blowing agents of the presently disclosed technology may be any of those known in the art. In general, blowing agents of the present disclosure are liquids having a boiling point between −50° C. and 100° C., such as between 0° C. and 50° C. Some examples of organic physical co-blowing agents that can be used in the present disclosure include, but are not limited to, hydrocarbons, halogenated hydrocarbons, fluids with polar groups such as ethers, esters, acetals, carbonates, alkanols, amines and ketones, and combinations thereof. Examples of hydrocarbons include, but are not limited to, methane, ethane, propane, cyclopropane, normal- (n-) or iso-butane, cyclobutane, neopentane, normal pentane, cyclopentane and isopentane, or any combination thereof. Halogenated hydrocarbons include, but are not limited to, methyl fluoride, difluoromethane (HFC-32), trifluoromethane (HFC-23), perfluoromethane, chlorodifluoromethane (HCFC-22), methylene chloride, ethyl chloride, ethyl fluoride, 1,2-difluoroethane (HFC-152), 1,1-difluoroethane (HFC-152a), 1,1,1-trifluoroethane (HFC-143a), 1,1,2,2-tetrafluoroethane (HFC-134), 1,1,1,2-tetrafluoroethane (HFC-134a), pentafluoroethane (HFC-125), perfluoroethane, 1,1-dichloro-1-fluoroethane (HCFC-141 b), 1-chloro-1,1-difluoroethane (HCFC-142b), 1,1-dichloro-2,2,2-trifluoroethane (HCFC-123), and 1-chloro-1,2,2,2-tetrafluoroethane (HCFC-124), difluoropropane, 1,1,1-trifluoropropane, 1,1,1,3,3-pentafluoropropane (HFC-245fa), 1,1,1,2,3,3-hexafluoropropane (HFC-236ea), 1,1,1,2,3,3,3-heptafluoropropane (HFC-227ea), perfluoropropane, 2,2,4,4,4-pentafluorobutane (HFC-365mfc), perfluorobutane, perfluorocyclobutane, and vinyl fluoride, or any combination thereof. Fluids with polar groups include but are not limited to ethers such as dimethyl ether, vinyl methyl ether, methyl ethyl ether, dimethyl fluoroether, diethyl fluoroether, and perfluorotetrahydrofuran; amines such as dimethylamine, trimethylamine and ethylamine; ketones such as acetone and perfluoroacetone; esters such as ethyl formate and methyl acetate; acetals such as methylal; carbonates such as dimethyl carbonate; alkanols such as ethanol or any combination thereof. Blowing agents of the present disclosure further include hydrocarbons, such as hydrocarbons containing two to five carbon atoms (such as any of 2, 3, 4, or 5 carbon atoms), a halogenated hydrocarbon, an ether, an alkanol, a ketone, water, carbon dioxide, or any combination thereof. Blowing agents of the present disclosure may include combinations of water and hydrocarbons, such as normal pentane, isopentane and cyclopentane. Fluorinated blowing agents or methyl formate may also be used as a blowing agent. Silane blowing agents may also include tetramethylsilane and hexamethyldisiloxane. The blowing agents may be pre-mixed with the polyol ingredients prior to reaction with the aromatic organic isocyanate, or a portion of the blowing agents may be added to the polyol composition prior to reaction with the isocyanate with the remainder of the blowing agents concurrently added as a separate stream, or a portion of the blowing agent ingredients may be premixed with the isocyanate prior to reaction. The polyol ingredients may be mixed with the blowing agents to form a premix of the present disclosure, after which an aromatic organic isocyanate is added to make an open or closed cell rigid polyisocyanurate foam of the present disclosure.

Any organic polyisocyanate can be employed in the preparation of the rigid polyisocyanurate foams. The organic polyisocyanates which can be used include aromatic, aliphatic and cycloaliphatic polyisocyanates and combinations thereof. Such polyisocyanates are described, for example, in U.S. Pat. Nos. 4,795,763, 4,065,410, 3,401,180, 3,454,606, 3,152,162, 3,492,330, 3,001,973, 3,394,164 and 3,124,605, all of which are incorporated herein by reference. Representative of the polyisocyanates are IA the diisocyanates such as m-phenylene diisocyanate, toluene-2,4-diisocyanate, toluene-2,6-diisocyanate, mixtures of 2,4- and 2,6-toluene diisocyanate, hexamethylene-1,6-diisocyanate, tetramethylene-1,4-diisocyanate, cyclohexane-1,4-diisocyanate, hexahydrotoluene 2,4- and 2,6-diisocyanate, naphthalene-1,5-diisocyanate, diphenyl methane-4,4′-diisocyanate, 4,4′-diphenylenediisocyanate, 3,3′-dimethoxy-4,4′-biphenyl-diisocyanate, 3,3′-dimethyldiphenylmethane-4,4′-diisocyanate; the triisocyanates such as 4,4′,4′-triphenylmethane-triisocyanate, polymethylenepolyphenyl isocyanate, toluene-2,4,6-triisocyanate; and the tetraisocyanates such as 4,4′-dimethyldiphenylmethane-2,2′,5,5′-tetraisocyanate and polymeric forms of any of the above mentioned isocyanate compounds. Prepolymers may also be employed in the preparation of the foams described herein. These prepolymers are prepared by reacting an excess of organic polyisocyanate or mixtures thereof with a minor amount of an active hydrogen-containing compound as determined by the well-known Zerewitinoff test, as described by Kohler in “Journal of the American Chemical Society,” 49, 3181(1927). Any such compound can be employed in the practice of the presently disclosed technology. Isocyanates used according to the presently disclosed technology include, but are not limited to Mondur 489 (Bayer), Rubinate 1850 (Huntsman), Luprinate M70L (BASF) and Papi 580 (Dow). Isocyanate indices greater than about 200, such as from 200-500 are described herein and are a part of the presently described technology. The isocyanate index of the formulations of the presently disclosed formulations may be in the range of 150-400, but preferably from about 200-325.

Flame retardants of the presently disclosed technology may be non-reactive or reactive, as described above. Reactive flame retardants, such as E06-16, produced by ICL, contain isocyanate reactive groups which become part of the polymer matrix thereby producing a product which contains a non-leachable flame resistant moiety. Moreover, flame retardants of the presently disclosed technology may be halogenated or non-halogenated. Non-limiting examples of non-halogenated, non-reactive flame retardants useful in the presently disclosed technology include, for example, Fyrol HF4 (ICL), Fyrol Hf5 (ICL), Fyrol PNX (ICL), Fyrolflex RDP/RDH-HP (ICL), Phireguard BDP (Yoke Chemical), Phireguard RDP (Yoke Chemical), Phireguard TEP (Yoke Chemical), Phireguard HL-88 (Yoke Chemical), Phireguard TPP (Yoke Chemical), alkyl aryl phosphates and DMMP (dimethyl methylphosphonate). Non-limiting examples of non-halogenated, reactive flame retardants useful in the presently disclosed technology include, for example, Fyrol 6 (ICL), E06-16 (ICL) and Exolit OP-500 Series (Clariant). Non-limiting examples of halogenated, non-reactive flame retardants useful in the presently disclosed technology include, for example, Fyrol PCF (ICL) and TCEP (Tris(2-chloroethyl)phosphate). Non-limiting examples of halogenated, reactive flame retardants useful in the presently disclosed technology include, for example, FR-513 (ICL), FR-522 (ICL), Safron 6605 (ICL) and Saytex RB-79 (Albemarle).

Flame retardants of the presently disclosed technology include, but are not limited to, phosphorus, sulfur and/or halogen containing compounds. Fire retardants of the presently disclosed formulations may include Tris(1,3-dichloro-2-propyl)phosphate (TDCPP), Tris(2-chloroethyl)phosphate (TCEP), Tris(1-chloro-2-propyl)phosphate (TCPP), Firemaster 550 (combination of triphenyl phosphate (TPP), bis (2-ethylhexyl) tetrabromophthalate (TBPH), 2-ethylhexyl-2,3,4,5-tetrabromobenzoate (TBB), and a suite of triaryl phosphate isomers), diethylethylphosphonate (DEEP). triethylphosphate (TEP), ammonium polyphosphate-APP, melamine, aluminum trihydrate (ATH), boric acid, boron decahydrate, elemental phosphorous, a phosphonate, a phosphate, elemental sulfur, a sulfur containing compound, such as sulfuric acid or a sulphonate or any halogenated compound.

Flame retardants may be present in compositions of the presently disclosed technology in an amount that provides a desired effect as is described herein. The amount of flame retardant may be adjusted to provide greater volume expansion of the foams described herein under flame conditions, or to maintain an acceptable level of expansion under flame conditions while reducing the amount of alkali metal and/or alkali earth metal to acceptable and/or desired amounts. The amount of flame retardant component (phosphorous, sulfur, and/or halogen (such as bromine and/or chlorine)) present in compositions of the presently disclosed technology may be less than 20,000 ppm (by weight of the weight of foam), or less than 19,000 ppm, or less than 18,000 ppm, or less than 17,000 ppm, or less than 16,000 ppm, or less than 15,000 ppm, or less than 14,000 ppm, or less than 13,000 ppm, or less than 12,000 ppm, or less than 11,000 ppm, or less than 10,000 ppm, or less than 9,000 ppm, or less than 8,000 ppm, or less than 7,000 ppm, or less than 6,000 ppm or less than 5,000 ppm, or less than 4,000 ppm, or less than 3,000 ppm, or less than 2,000 ppm, or less than 1,500 ppm, or less than 1,000 ppm, for example,

The efficiency of the flame retardants in the presently disclosed technology may vary such that, for example, the amount of chlorine, for example, required for a desired effect may be greater than, for example, the amount of bromine required for the same effect, which may be more than the amount of phosphorous required for comparable effect. The amount therefore of non-reactive, non-halogenated and reactive non-halogenated flame retardant required to produce a desired effect may be less than the amount of non-reactive halogenated or reactive halogenated flame retardant required to produce a similar result.

Chlorinated flame retardants may be present in compositions of the presently disclosed technology in an amount, for example, less than 20,000 ppm chlorine (by weight) as described above. Brominated flame retardants may be present in compositions of the presently disclosed technology in an amount, for example, less than 7,000 ppm bromine (by weight) or less than 6,000 ppm or less than 5,000 ppm, or less than 4,000 ppm, or less than 3,000 ppm, or less than 2,000 ppm, or less than 1,500 ppm, or less than 1,000 ppm, for example, as described above and herein. Non-halogenated flame retardants may be present in compositions of the presently disclosed technology in an amount, for example, less than 6,000 ppm phosphorous (by weight), or less than 5,000 ppm, or less than 4,000 ppm, or less than 3,000 ppm, or less than 2,000 ppm, or less than 1,500 ppm, or less than 1,000 ppm, for example, as described above and herein.

As described above, the amount of intumescence of foam compositions of the presently disclosed technology under flame conditions is directly related to the molar ratio of flame retardant component (phosphorous, sulfur, and/or halogen (such as bromine and/or chlorine)) and the alkali metal and/or alkali earth metal present in the composition. Molar ratios may be adjusted to provide a desired volume of the foam under flame conditions. Generally, the ratio may vary between 2:1 to 35:1, such as 3:1 to 35:1, or 4:1 to 35:1, or 5:1 to 35:1, or 6:1 to 35:1, or 7:1 to 35:1 or 8:1 to 35:1 or 9:1 to 35:1 or 10:1 to 35:1, or 12:1 to 35:1, or 15:1 to 35:1, or 17:1 to 35:1, or 20:1 to 35:1, or 22:1 to 35:1, or 25:1 to 35:1, or 27:1 to 35:1, or intermediate ranges within these ranges, depending on the desired effect on volume and the flame retardant component. A ratio of infinity is most desired due to the elimination of alkali metals and/or alkali earth metals.

Specifically, for example, when the molar ratio of phosphorous flame retardant component provided by a non-reactive, non-halogenated or reactive, non-halogenated flame retardant to alkali or alkali earth metal is greater than or equal to about 3:1, the volume of the foam containing same will show limited volume change (as a percent of the original volume) under flame conditions (such as may be measured by the method of the following examples). The molar ratio may be increased as desired to increase the volume of the foam under flame conditions and decreasing the ratio will decrease the volume of the foam under flame conditions. It will be appreciated that an amount of decreased volume under flame conditions may be acceptable and/or expected (such as up to 25-30% loss in volume) such that the molar ratio of phosphorous flame retardant component provided by a non-reactive, non-halogenated or reactive, non-halogenated flame retardant to alkali or alkali earth metal of less than about 3:1 may provide acceptable levels of volume change under flame conditions.

Moreover, when the molar ratio of sulfur flame retardant component provided by a non-reactive, non-halogenated or reactive, non-halogenated flame retardant to alkali or alkali earth metal is greater than or equal to about 3:1, the volume of the foam containing same will show limited volume change (as a percent of the original volume) under flame conditions (such as may be measured by the method of the following examples). The molar ratio may be increased as desired to increase the volume of the foam under flame conditions and decreasing the ratio will decrease the volume of the foam under flame conditions. It will be appreciated that an amount of decreased volume under flame conditions may be acceptable and/or expected (such as up to 25-30% loss in volume) such that the molar ratio of sulfur flame retardant component provided by a non-reactive, non-halogenated or reactive, non-halogenated flame retardant to alkali or alkali earth metal of less than about 3:1 may provide acceptable levels of volume change under flame conditions.

Moreover, when the molar ratio of bromine flame retardant component provided by a non-reactive, halogenated or reactive, halogenated flame retardant to alkali or alkali earth metal is greater than or equal to about 5:1, the volume of the foam containing same will show limited volume change (as a percent of the original volume) under flame conditions (such as may be measured by the method of the following examples). The molar ratio may be increased as desired to increase the volume of the foam under flame conditions and decreasing the ratio will decrease the volume of the foam under flame conditions. It will be appreciated that an amount of decreased volume under flame conditions may be acceptable and/or expected (such as up to 25-30% loss in volume) such that the molar ratio of bromine flame retardant component provided by a non-reactive, halogenated or reactive, halogenated flame retardant to alkali or alkali earth metal of less than about 5:1 may provide acceptable levels of volume change under flame conditions.

Further, when the molar ratio of chlorine flame retardant component provided by a non-reactive, halogenated or reactive, halogenated flame retardant to alkali or alkali earth metal is greater than or equal to about 9:1, the volume of the foam containing same will show limited volume change (as a percent of the original volume) under flame conditions (such as may be measured by the method of the following examples). The molar ratio may be increased as desired to increase the volume of the foam under flame conditions and decreasing the ratio will decrease the volume of the foam under flame conditions. It will be appreciated that an amount of decreased volume under flame conditions may be acceptable and/or expected (such as up to 25-30% loss in volume) such that the molar ratio of chlorine retardant component provided by a non-reactive, halogenated or reactive, halogenated flame retardant to alkali or alkali earth metal of less than about 9:1 may provide acceptable levels of volume change under flame conditions.

The present disclosure provides a flame retardant containing polyurethane and/or polyisocyanurate foam compositions wherein the molar ratio of flame retardant component to alkali metal and/or alkali earth metal of the foam is greater than 2.5:1, the foam composition containing less than 1500 ppm (by weigh of total weight of foam) of an alkali metal and/or alkali earth metal, wherein the foamed composition has improved thermal stability as compared to a similar foamed composition with a lower molar ratio of flame retardant component to alkali metal and/or alkali earth metal.

The present disclosure provides a flame retardant containing polyurethane and/or polyisocyanurate foam compositions wherein the molar ratio of flame retardant component to alkali metal and/or alkali earth metal of the foam is greater than 2.5:1, wherein the flame retardant component is phosphorus or sulfur, the foam composition containing less than 1500 ppm (by weigh of total weight of foam) of an alkali metal and/or alkali earth metal, wherein the foamed composition has improved thermal stability as compared to a similar foamed composition with a lower molar ratio of flame retardant component to alkali metal and/or alkali earth metal.

The present disclosure provides a flame retardant containing polyurethane and/or polyisocyanurate foam compositions wherein the molar ratio of flame retardant component to alkali metal and/or alkali earth metal of the foam is greater than 4.5:1, wherein the flame retardant component is bromine, the foam composition containing less than 1500 ppm (by weigh of total weight of foam) of an alkali metal and/or alkali earth metal, wherein the foamed composition has improved thermal stability as compared to a similar foamed composition with a lower molar ratio of flame retardant component to alkali metal and/or alkali earth metal.

The present disclosure provides a flame retardant containing polyurethane and/or polyisocyanurate foam compositions wherein the molar ratio of flame retardant component to alkali metal and/or alkali earth metal of the foam is greater than 8.5:1, wherein the flame retardant component is chlorine, the foam composition containing less than 1500 ppm (by weigh of total weight of foam) of an alkali metal and/or alkali earth metal, wherein the foamed composition has improved thermal stability as compared to a similar foamed composition with a lower molar ratio of flame retardant component to alkali metal and/or alkali earth metal.

Foam compositions of the present disclosure may maintain their volume or intumesces with a loss of no more than 30%, or 20%, or 10%, or 5%, in volume, or ranges between 30% and 0% loss in volume, as a result of exposure to heat.

Foam compositions of the present disclosure may increase in volume, such as by 5%, or 10%, or 15%, or 20%, or 25%, or 30%, or ranges between 0% and 30% increase in volume, as a result of exposure to heat.

Foam compositions of the present disclosure may contain a flame retardant component selected from at least one of a phosphorus, sulfur and/or halogen and the component is included in the foam as a reactive or non-reactive flame retardant.

Foam compositions of present disclosure may contain a molar ratio of flame retardant component to alkali metal and/or alkali earth metal of greater than 3:1, or greater than 3.5:1, or greater than 4:1, or greater than 4.5:1, or greater than 5:1, or greater than 5.5:1, or greater than 6:1, or greater than 6.5:1, or greater than 7:1, or greater than 8:1, or greater than 9:1; with less than 1500 ppm (by weigh of total weight of foam) of an alkali metal and/or alkali earth metal, or less than 1000 ppm (by weigh of total weight of foam) of an alkali metal and/or alkali earth metal, or less than 500 ppm (by weigh of total weight of foam) of an alkali metal and/or alkali earth metal, or no measurable amount of alkali metal and/or alkali earth metal.

Foam compositions of present disclosure may contain a flame retardant component in an amount of less than or equal to 6000 ppm (by weigh of total weight of foam), or less than or equal to 4000 ppm (by weigh of total weight of foam), or an amount of less than or equal to 2000 ppm (by weigh of total weight of foam).

Foam compositions of present disclosure may contain a flame retardant component which is not a halogen.

Foam compositions of present disclosure may contain a reactive flame retardant and/or a non-reactive flame retardant.

The present disclosure provides building materials containing a foamed form of a composition described herein.

The present disclosure provide a method producing a foam composition of the present disclosure wherein the method includes combining polyisocyanurate foam composition ingredients with a flame retardant component.

The present disclosure provides an improved flame retardant containing polyisocyanurate foam composition, wherein the improvement includes less than 1500 ppm (by weight of the total weight of foam) of an alkali metal and/or alkali earth metal, and a molar ratio of flame retardant component to alkali metal and/or alkali earth metal of the foam of greater than 2.5:1.

The present disclosure provides a method of reducing the amount of flame retardant in a flame retardant containing polyurethane and/or polyisocyanurate foam composition without degrading or reducing the thermal stability of the composition under flame conditions, the method involving including less than 1500 ppm (by weigh of total weight of foam) alkali metal and/or alkali earth metal to the flame retardant containing polyurethane and/or polyisocyanurate foam composition with a reduced the amount of flame retardant component, while also optionally including a flame retardant component and alkali metal and/or alkali earth metal in a molar ratio of flame retardant component to alkali metal and/or alkali earth metal of the foam of greater than 2.5:1. The thermal stability which is not degraded or reduced may include maintaining the volume of the foam under flame conditions. Methods of the present disclosure may include a reduced amount of flame retardant component which is at least one of a phosphorus, sulfur and/or halogen and the component may be included in the foam as a reactive or non-reactive flame retardant. The methods of the present disclosure may involve including less than 1000 ppm, or less than 500 ppm (by weigh of total weight of foam) alkali metal and/or alkali earth metal, or no alkali metal and/or alkali earth metal, to the flame retardant containing polyurethane and/or polyisocyanurate foam composition.

The reduced amounts of flame retardant component included in methods of the present disclosure may be less than or equal to 6000 ppm (by weigh of total weight of foam), or less than or equal to 4000 ppm (by weigh of total weight of foam), or less than or equal to 2000 ppm (by weigh of total weight of foam).

### Examples

The examples of the presently disclosed technology listed below are to be used as an illustration, and should not be consider limiting in any way. All examples are given in percentage by weight of total foam unless described otherwise.

Lab Prepared Hand Mix Foam Procedure

The b-blend components, which include the isocyanate reactive component, surfactant, catalysts, water and flame retardant are carefully weighed per the formulation into a 16-oz, wide mouth polyethylene jar. This b-blend is then placed under a high shear mixer and mixed for 30-seconds (as measured by a stopwatch). A lid is then placed on the jar and the sample is then allowed to condition for a minimum of 2-hours and a maximum of 24-hours. Once the initial b-blend has been allowed to condition, the sample is removed from the incubator and placed on a scale. The blowing agent is then added to b-blend mixture. The sample is then placed under a high shear mixer and carefully mixed for 45-seconds (as measured by a stopwatch). The b-blend is then quickly added to a clean 1000-mL plastic beaker per the formulation. The MDI is then added to the b-blend in the plastic beaker. The mixture is then quickly placed under a high shear mixer, a stopwatch shall be started and the mixture shall be mixed for 6-seconds (as measured by a stopwatch). The beaker containing the mixture is then carefully, but quickly placed into the fiber bucket such that the beaker fits down into the hole cut in the bottom of the 165-oz fiber bucket. The foam is then allowed to rise.

Muffle Furnace Procedure

The muffle furnace test was developed within the industry as a screening tool for determining which formulations had the best chance of passing the Factory Mutual Roof calorimeter test (FM 4450). A foam sample having dimensions of around 4″×4″ and having a thickness of around 1″ is cut from a lab produced foam head or a foam board produced on a laminator. The length, width and thickness are then measured with a dial caliper and recorded. The foam sample is then wrapped in aluminum foil and placed in a metal chase, with a metal top placed on the sample. The chase with the foam sample is then placed in a muffle furnace for 20-minutes at 450° C. The metal chase is then removed from the muffle furnace and allowed to cool. Once the chase is cool, the sample is removed from the chase and the aluminum foil is carefully removed. The length, width and thickness of the remaining foam carcass is then measured and recorded. These values are used to determine the % change in volume.

Examples of Table 1:

TABLE 1

| Reagent | Description | 1 | 2 | 3 |
|---|---|---|---|---|
| Stepan PS-2602 | Polyol | 25.90% | 26.64% | 28.70% |
| Airproducts TMR-7 | Nonalkali Trimer Catalyst 1 | — | — | 0.25% |
| Huntsman Z-110 | Nonalkali Trimer Catalyst 2 | — | — | 0.43% |
| Pelron Pel-cat 9749-A | Amine Blow Catalyst | 0.14% | 0.14% | 0.23% |
| Pelron Pel-cat 9648-A | Potassium Acetate | 0.28% | 0.29% | — |
| Pelron Pel-cat 9540-A | Potassium Octoate | 1.37% | 1.41% | — |
| Shekoy Phireguard TCPP | Halogenated Flame Retardant | 4.90% | 2.16% | 2.32% |
| Pelron Pel-sil 107-A | Surfactant | 0.56% | 0.57% | 0.62% |
| | WATER | 0.14% | 0.14% | 0.16% |
| | PENTANE | 7.18% | 7.38% | 7.95% |
| BASF Lupranate M70L | Isocyanate | 59.54% | 61.26% | 59.33% |
| | Index | 285 | 285 | 285 |
| | Core Density (pcf) | 1.61 | 1.61 | 1.59 |
| | Muffle Furnace % Change in Volume | −15% | −37% | 36% |
| | ppm K (by weight) | 1894 | 1951 | 0 |
| | Moles Potassium/million grams of foam | 48 | 50 | 0 |
| | PPM P (by weight) | 4655 | 2052 | 2204 |
| | Moles Phosphorus/million grams of foam | 150 | 66 | 71 |
| | PPM Cl (by weight) | 15925 | 7020 | 7540 |
| | Moles Chlorine/million grams of foam | 449 | 198 | 213 |
| | Phosphorus:Alkali Weight Ratio | 2.5:1 | 1:1 | Infinity |
| | Phosphorus:Alkali Mole Ratio | 3:1 | 1.5:1 | Infinity |
| | Chlorine:Alkali Weight Ratio | 8.5:1 | 3.5:1 | Infinity |
| | Chlorine:Alkali Mole Ratio | 9:1 | 4:1 | Infinity |

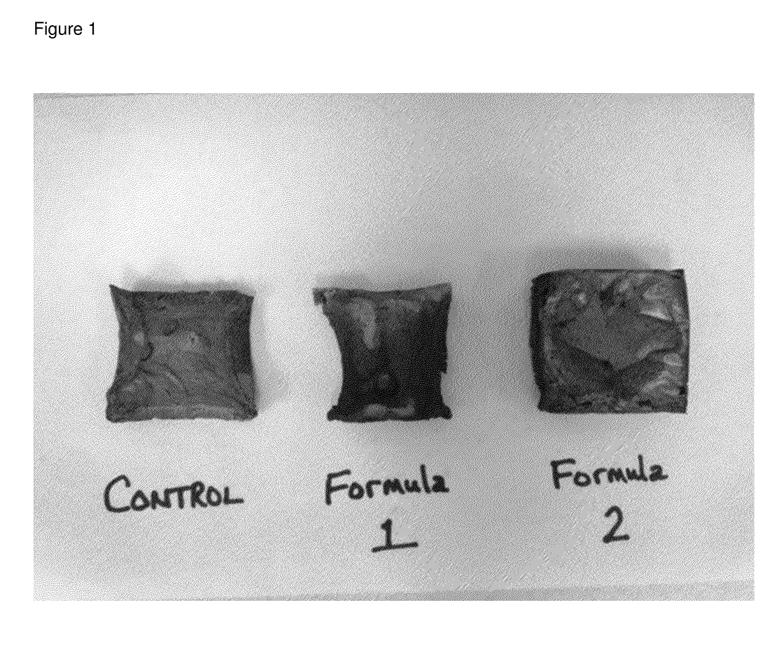

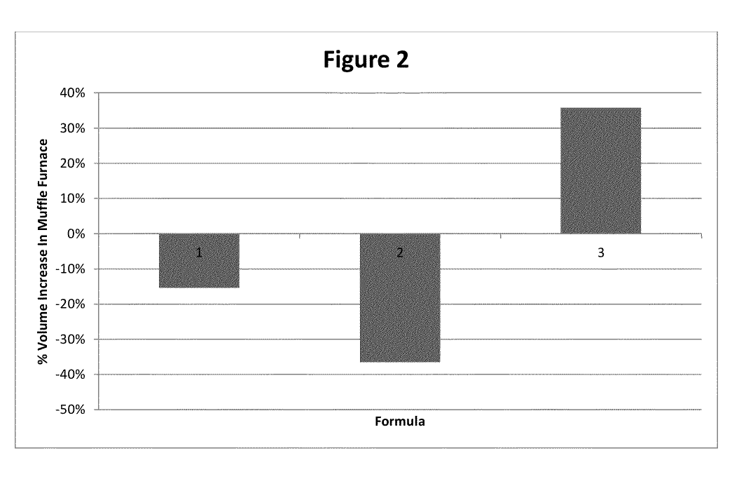

The examples shown in Table 1 and FIGS. 1 and 2 demonstrate the effect that removing the alkali metal containing catalyst has on the burn performance of the foam. Formulas 1 and 2, which contain alkali catalyst, exhibited shrinkage in the muffle furnace at both 4.90% and 2.16% TCPP fire retardant. Formula 3, however, which contains no alkali catalysts, exhibits an increase in volume in the muffle furnace, even at the reduced flame retardant loading of 2.32%. This demonstrates the ability to reduce flame retardant and still maintain thermal stability when reducing the presence of alkali metal catalyst.

Examples of Table 2

TABLE 2

| Reagent | Description | 1 | 2 | 3 | 4 | 5 |
|---|---|---|---|---|---|---|
| Stepan PS-2602 | Polyol | 26.16% | 25.56% | 25.04% | 24.51% | 24.85% |
| Huntsman Z- | Nonalkali Trimer Catalyst | 0.37% | 0.37% | 0.37% | 0.37% | — |
| 110 | 1 | | | | | |
| Pel-ron Pel-cat | Nonalkali Trimer Catalyst | 0.55% | 0.55% | 0.55% | 0.55% | — |
| 9715 | 2 | | | | | |
| Pel-ron Pel-cat | Amine Blow Catalyst | 0.14% | 0.14% | 0.14% | 0.14% | 0.14% |
| 9749-A | | | | | | |
| Pel-ron Pel-cat | Potassium Acetate | — | — | — | — | 0.27% |
| 9648-A | | | | | | |
| Pel-ron Pel-cat | Potassium Octoate | — | 0.40% | 0.79% | 1.19% | 1.36% |
| 9540-A | | | | | | |
| Shekoy | Halogenated Flame | 4.75% | 4.75% | 4.75% | 4.75% | 4.75% |
| Phiregard TCPP | Retardant | | | | | |
| Pel-ron Pel-sil | Surfactant | 0.54% | 0.54% | 0.54% | 0.54% | 0.54% |
| P-107 | | | | | | |
| | WATER | 0.14% | 0.14% | 0.14% | 0.14% | 0.14% |
| | PENTANE | 7.29% | 7.19% | 7.09% | 6.99% | 6.89% |
| Bayer M-489 | Isocyanate | 60.04% | 60.35% | 60.59% | 60.83% | 61.05% |
| | Index | 300 | 300 | 300 | 300 | 300 |
| | Core Density (pcf) | 1.73 | 1.69 | 1.69 | 1.68 | 1.71 |
| | Muffle Furnace % Change | 58% | 49% | 23% | 18% | −1% |
| | in Volume | | | | | |
| | ppm K (by weight) | 0 | 500 | 1000 | 1500 | 1880 |
| | Moles Potassium/million | 0 | 13 | 26 | 38 | 48 |
| | grams of foam | | | | | |
| | ppm P (by weight) | 4516 | 4516 | 4512 | 4510 | 4512 |
| | Moles | 146 | 146 | 146 | 146 | 146 |
| | Phosphorus/million | | | | | |
| | grams of foam | | | | | |
| | ppm Cl (by weight) | 15451 | 15448 | 15435 | 15430 | 15434 |
| | Moles Chlorine/million | 436 | 436 | 435 | 435 | 435 |
| | grams of foam | | | | | |
| | Phosphorus:Alkali | Infinity | 9:1 | 4.5:1 | 3:1 | 2.5:1 |
| | Weight Ratio | | | | | |
| | Phosphorus:Alkali Mole | Infinity | 11.5:1 | 5.5:1 | 4:1 | 3:1 |
| | Ratio | | | | | |
| | Chlorine:Alkali Weight | Infinity | 31:1 | 15.5:1 | 10:1 | 8:1 |
| | Ratio | | | | | |
| | Chlorine:Alkali Mole | Infinity | 34:1 | 17:1 | 11:1 | 9:1 |
| | Ratio | | | | | |

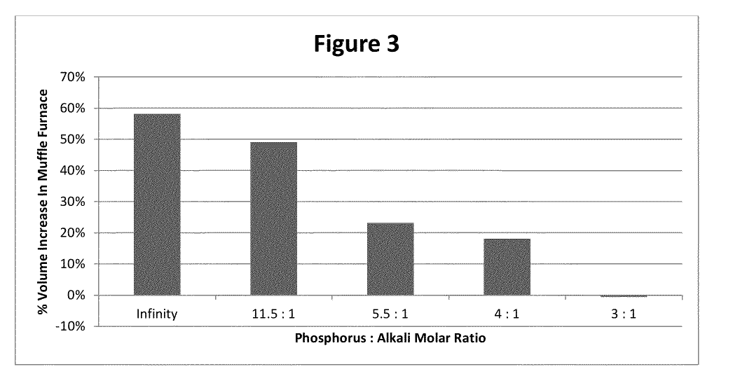

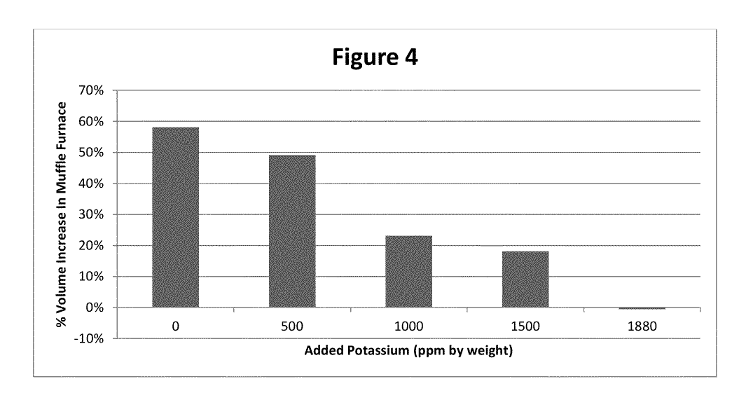

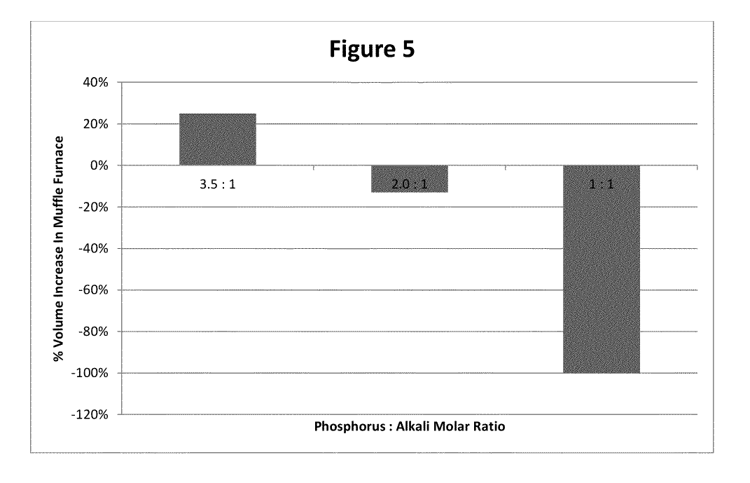

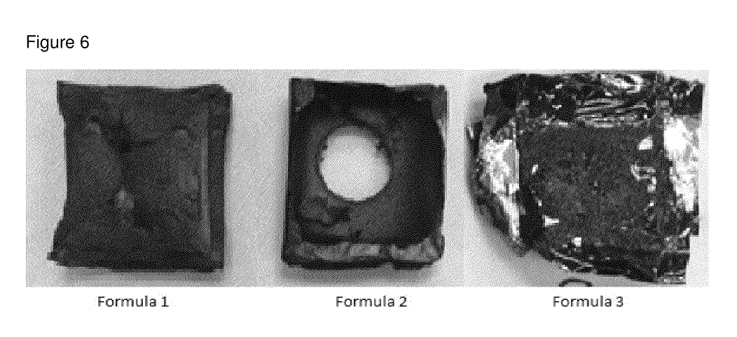

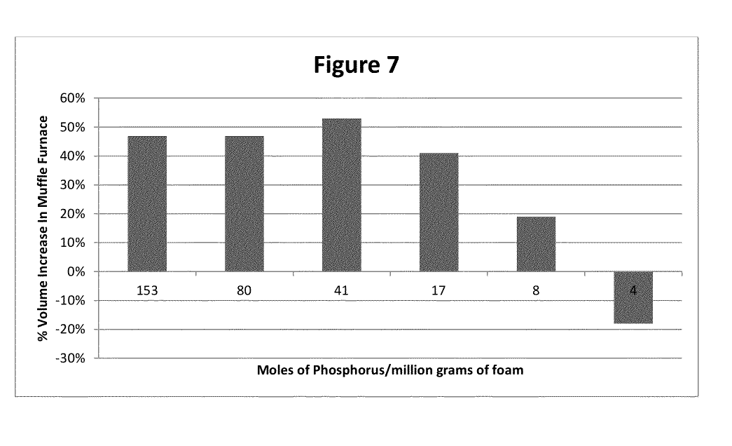

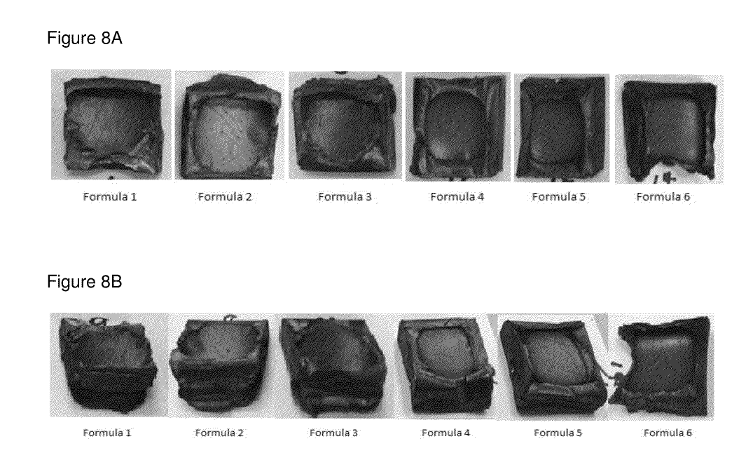

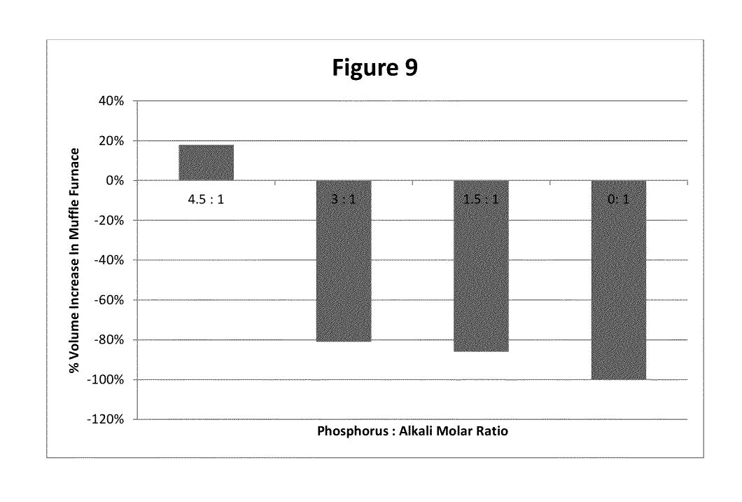

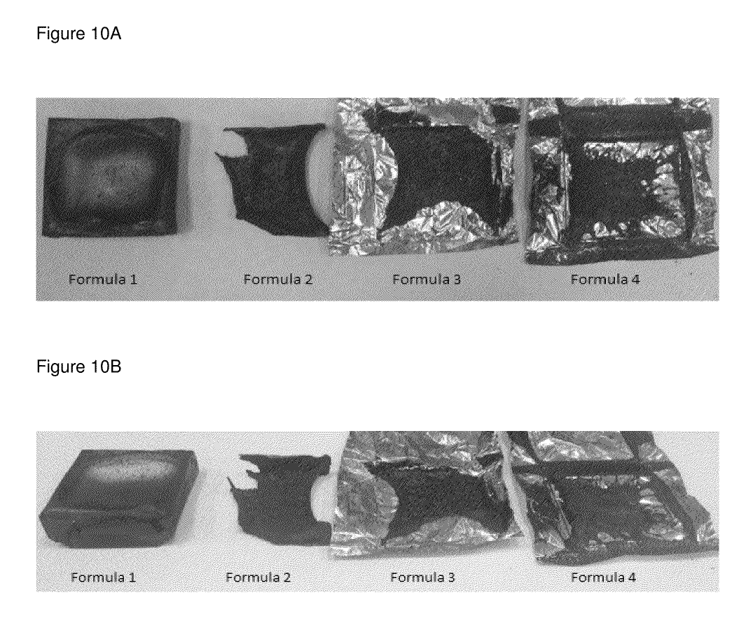

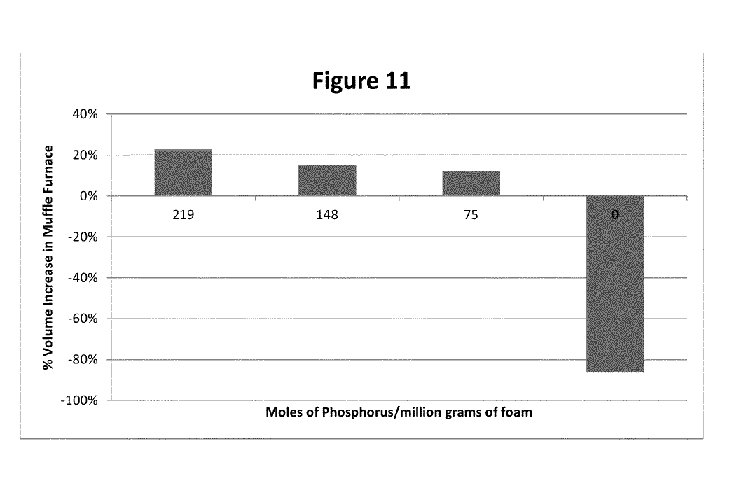

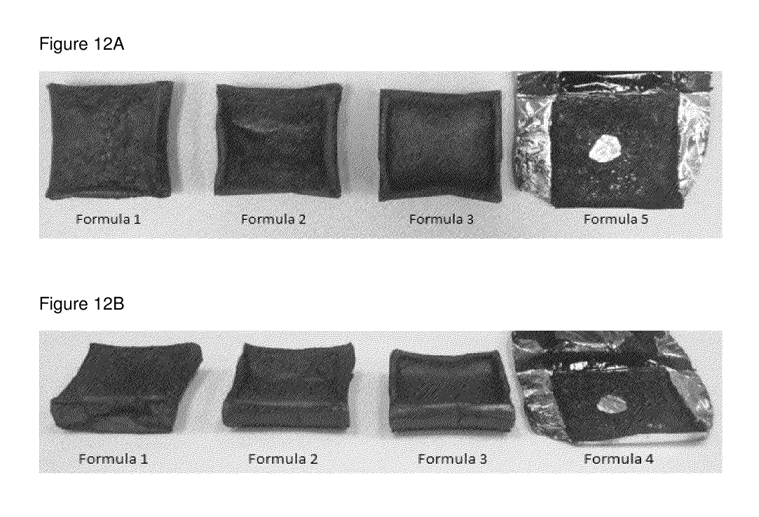

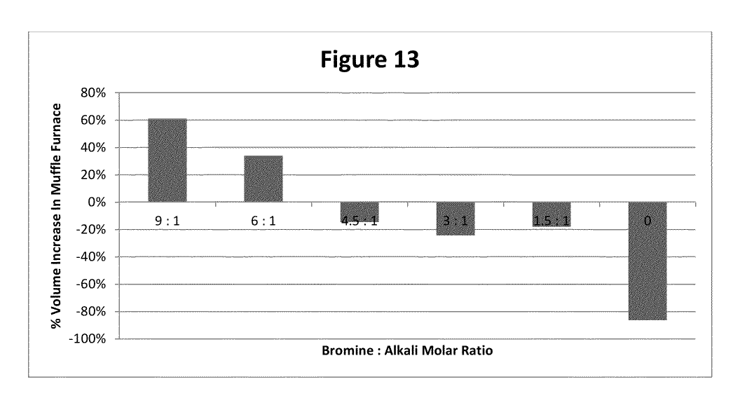

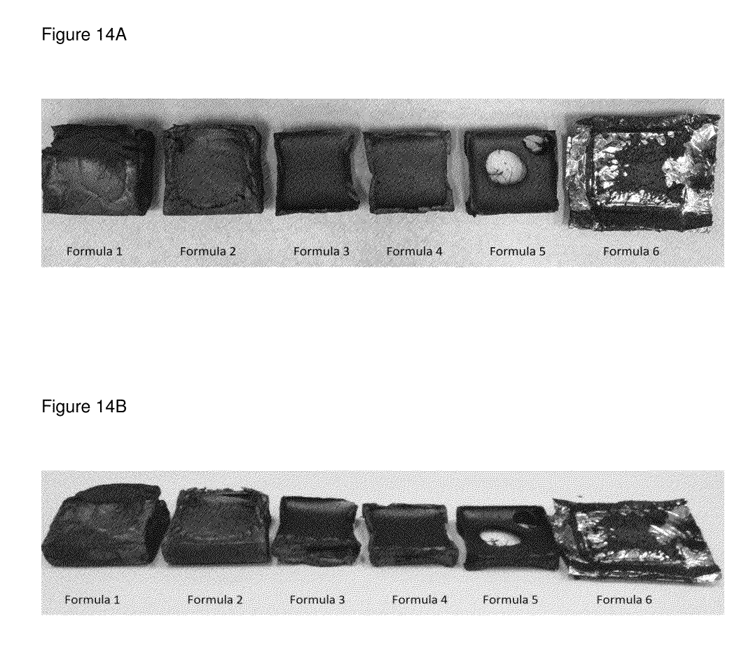

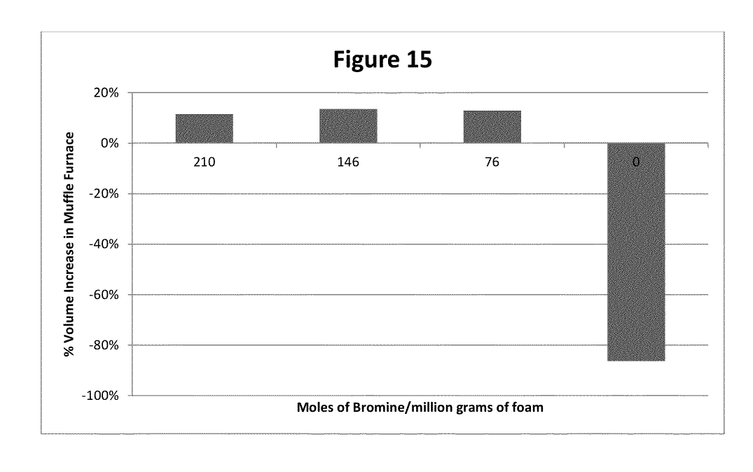

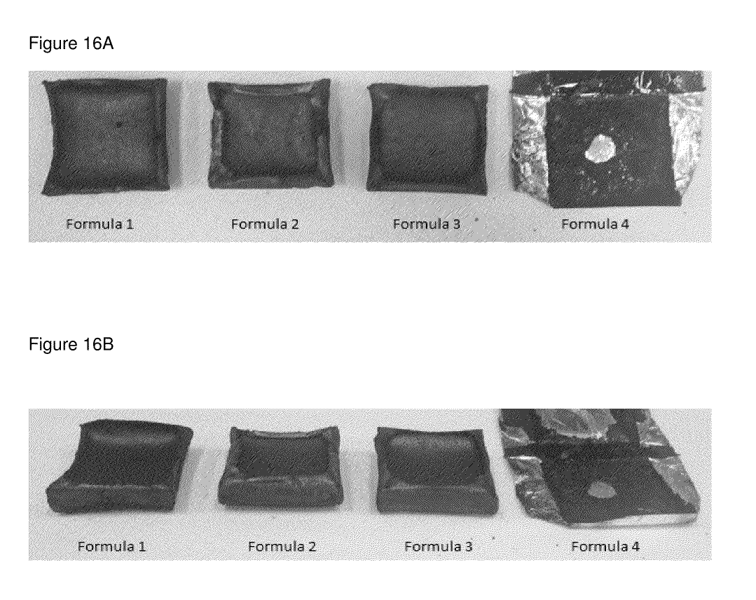

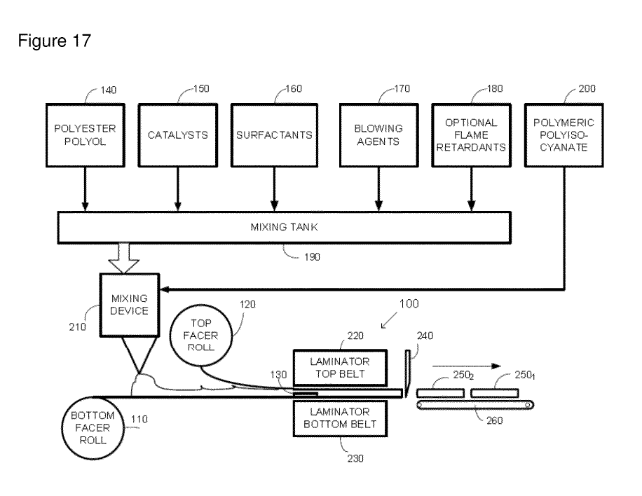

The examples shown in Table 2, FIG. 3 and FIG. 4 demonstrate the effect that specific amounts of alkali metal have on the burn performance of the foam in the muffle furnace. It can be seen in this example that at 1800-ppm the foam does have some shrinkage, however, as the presence of alkali is reduced the foam begins to expand respectively.

Examples of Table 3

TABLE 3

| Reagent | Description | 1 | 2 | 3 |
|---|---|---|---|---|
| Stepan PS-2602 | Polyol | 25.60% | 26.81% | 27.46% |
| | Nonalkali Trimer Catalyst 1 | — | — | — |
| | Nonalkali Trimer Catalyst 2 | — | — | — |
| Pel-ron Pel-cat 9749-A | Amine Blow Catalyst | 0.09% | 0.09% | 0.10% |
| Pel-ron Pel-cat 9648-A | Potassium Acetate | 0.13% | 0.13% | 0.14% |
| Pel-ron Pel-cat 9540-A | Potassium Octoate | 1.28% | 1.34% | 1.37% |
| ICL E06-16 | Non-halogenated Flame Retardant | 2.55% | 1.34% | 0.69% |
| Pel-ron Pel-sil P-107 | Surfactant | 0.51% | 0.54% | 0.55% |
| | WATER | 0.10% | 0.11% | 0.11% |
| | PENTANE | 6.89% | 6.89% | 6.89% |
| Bayer M-489 | Isocyanate | 62.84% | 62.75% | 62.70% |
| | Index | 283 | 283 | 283 |
| | Core Density (pcf) | 1.71 | 1.68 | 1.65 |
| | Compressive Strength (psi) | 24 | 25 | 22 |
| | Muffle Furnace % Change in Volume | 25% | −13% | −100% |
| | PPM K (by weight) | 1690 | 1769 | 1812 |
| | Moles Potassium/million grams of foam | 43 | 45 | 46 |
| | PPM P (by weight) | 4718 | 2480 | 1270 |
| | Moles Phosphorus/million grams of foam | 152 | 80 | 41 |
| | Phosphorus:Alkali Weight Ratio | 3.0:1 | 1.5:1 | 0.5:1 |
| | Phosphorus:Alkali Mole Ratio | 3.5:1 | 2.0:1 | 1:1 |

The examples shown in Table 3 demonstrate the inability to reduce flame retardant in a formula with alkali containing catalyst. Formula's 1-3 represent alkali containing formulas with reducing amounts of the E06-16, non-halogenated, fire retardant. As the fire retardant is reduced from 2.55% to 1.34% and then to 0.69%, it can be seen that the high temperature performance of the foam is greatly compromised with the muffle furnace % change in volume going from 25% to −13% to a foam that completely decomposes, respectively. Formula 2 demonstrates a reduction in muffle furnace volume which may be acceptable (i.e., 13% reduction) where the molar ratio of phosphorous to alkali is 2:1.

Examples of Table 4

TABLE 4

| Reagent | Description | 1 | 2 | 3 | 4 | 5 | 6 |
|---|---|---|---|---|---|---|---|
| Stepan PS- | Polyol | 25.54% | 26.74% | 27.39% | 27.79% | 27.93% | 28.00% |
| 2602 | | | | | | | |
| Huntsman Z- | Nonalkali Trimer Catalyst | 0.45% | 0.47% | 0.48% | 0.49% | 0.49% | 0.49% |
| 110 | 1 | | | | | | |
| Pel-ron Pel-cat | Nonalkali Trimer Catalyst | 1.02% | 1.07% | 1.10% | 1.11% | 1.12% | 1.12% |
| 9715 | 2 | | | | | | |
| Pel-ron Pel-cat | Amine Blow Catalyst | 0.13% | 0.13% | 0.14% | 0.14% | 0.14% | 0.14% |
| 9749-A | | | | | | | |
| | Potasium Acetate | — | — | — | — | — | — |
| | Potassium Octoate | — | — | — | — | — | — |
| ICL E06-16 | Non-halogenated Flame | 2.55% | 1.34% | 0.68% | 0.28% | 0.14% | 0.07% |
| | Retardant | | | | | | |
| Pel-ron Pel-sil | Surfactant | 0.51% | 0.53% | 0.55% | 0.56% | 0.56% | 0.56% |
| P-107 | | | | | | | |
| | WATER | 0.10% | 0.11% | 0.11% | 0.11% | 0.11% | 0.11% |
| | PENTANE | 6.89% | 6.89% | 6.89% | 6.89% | 6.89% | 6.89% |
| Bayer M-489 | Isocyanate | 62.81% | 62.72% | 62.67% | 62.63% | 62.63% | 62.62% |
| | Index | 283 | 283 | 283 | 283 | 283 | 283 |
| | Core Density (pcf) | 1.65 | 1.66 | 1.67% | 1.68% | 1.67% | 1.64% |
| | Compressive Strength | 27 | 22 | 25 | 27 | 25 | 26 |
| | (psi) | | | | | | |
| | Muffle Furnace % | 47% | 47% | 53% | 41% | 19% | −18% |
| | Change in Volume | | | | | | |
| | PPM K (by weight) | 0 | 0 | 0 | 0 | 0 | 0 |
| | Moles Potassium/million | 0 | 0 | 0 | 0 | 0 | 0 |
| | grams of foam | | | | | | |
| | PPM P (by weight) | 4725 | 2474 | 1267 | 514 | 258 | 129 |
| | Moles | 153 | 80 | 41 | 17 | 8 | 4 |
| | Phosphorus/million | | | | | | |
| | grams of foam | | | | | | |
| | Phosphorus:Alkali | Infinity | Infinity | Infinity | Infinity | Infinity | Infinity |
| | Weight Ratio | | | | | | |
| | Phosphorus:Alkali Mole | Infinity | Infinity | Infinity | Infinity | Infinity | Infinity |
| | Ratio | | | | | | |

The examples shown in Table 4 demonstrate the ability to reduce flame retardant in a formula with no added alkali containing catalyst. These results also demonstrate the volume increase under flame conditions attains a maximum whereby an increase in flame retardant does not increase the volume of the foam under flame conditions. It can be noted that the foam maintained its volume under high temperature at fire retardant loadings as low as 0.14% of total foam by weight.

Examples of Table 5

TABLE 5

| Reagent | Description | 1 | 2 | 3 | 4 |
|---|---|---|---|---|---|
| Stepan PS-2602 | Polyol | 26.38% | 26.83% | 27.25% | 27.83% |
| | Nonalkali Trimer Catalyst 1 | — | — | — | — |
| | Nonalkali Trimer Catalyst 2 | — | — | — | — |
| Pel-ron Pel-cat 9749-A | Amine Blow Catalyst | 0.14% | 0.14% | 0.14% | 0.14% |
| Pel-ron Pel-cat 9648-A | Potassium Acetate | 0.27% | 0.27% | 0.27% | 0.27% |
| Pel-ron Pel-cat 9540-A | Potassium Octoate | 1.36% | 1.36% | 1.36% | 1.36% |
| Ulterion TEP | Non-halogenated Flame Retardant | 3.96% | 2.68% | 1.36% | 0.00% |
| Pel-ron Pel-sil P-107 | Surfactant | 0.53% | 0.53% | 0.53% | 0.53% |
| | WATER | 0.14% | 0.14% | 0.14% | 0.14% |
| | PENTANE | 6.89% | 6.89% | 6.89% | 6.89% |
| Bayer M-489 | Isocyanate | 60.32% | 61.16% | 62.04% | 62.84% |
| | Index | 283 | 283 | 283 | 283 |
| | Core Density (pcf) | 1.63 | 1.63 | 1.68 | 1.66 |
| | Muffle Furnace % Change in Volume | 18% | −81% | −86% | −100% |
| | PPM K (by weight) | 1882 | 1875 | 1880 | 1882 |
| | Moles Potassium/million grams of foam | 48 | 48 | 48 | 48 |
| | PPM P (by weight) | 6728 | 4561 | 2316 | 0 |
| | Moles Phosphorus/million grams of foam | 217 | 147 | 75 | 0 |
| | Phosphorus:Alkali Weight Ratio | 3.5:1 | 2.5:1 | 1:1 | 0:1 |
| | Phosphorus:Alkali Mole Ratio | 4.5:1 | 3:1 | 1.5:1 | 0:1 |

The examples shown in Table 5 demonstrate the inability to reduce flame retardant in a formula with alkali containing catalyst. Formula's 1-4 represent alkali containing formulas with reducing amounts of the TEP, non-halogenated, fire retardant. As the fire retardant is reduced from 3.96% to 0%, it can be seen that the high temperature performance of the foam is greatly compromised with the muffle furnace % change in volume going from 18% to a foam that completely decomposes, respectively. Formula 1 is the only example that demonstrates what would be considered an acceptable muffle furnace performance.

Examples of Table 6

TABLE 6

| Reagent | Description | 1 | 2 | 3 | 4 |
|---|---|---|---|---|---|
| Stepan PS-2602 | Polyol | 26.60% | 27.02% | 27.47% | 28.00% |
| Airproducts TMR | Nonalkali Trimer Catalyst 1 | 1.62% | 1.62% | 1.62% | 1.62% |
| Pel-ron Pel-cat 9715 | Nonalkali Trimer Catalyst 2 | 0.19% | 0.19% | 0.19% | 0.19% |
| Pel-ron Pel-cat 9749-A | Amine Blow Catalyst | 0.09% | 0.09% | 0.09% | 0.09% |
| | Potassium Acetate | — | — | — | — |
| | Potassium Octoate | — | — | — | — |
| Ulterion TEP | Non-halogenated Flame Retardant | 3.99% | 2.70% | 1.37% | 0.00% |
| Pel-ron Pel-sil P-107 | Surfactant | 0.53% | 0.53% | 0.53% | 0.53% |
| | WATER | 0.14% | 0.14% | 0.14% | 0.14% |
| | PENTANE | 6.89% | 6.89% | 6.89% | 6.89% |
| Bayer M-489 | Isocyanate | 59.95% | 60.81% | 61.69% | 62.53% |
| | Index | 283 | 283 | 283 | 283 |
| | Core Density (pcf) | 1.64 | 1.69 | 1.71 | 1.70 |
| | Muffle Furnace % Change in Volume | 23% | 15% | 12% | −86% |
| | PPM K (by weight) | 0 | 0 | 0 | 0 |
| | Moles Potassium/million grams of foam | 0 | 0 | 0 | 0 |
| | PPM P (by weight) | 6782 | 4593 | 2335 | 0 |
| | Moles Phosphorus/million grams of foam | 219 | 148 | 75 | 0 |
| | Phosphorus:Alkali Weight Ratio | Infinity | Infinity | Infinity | Infinity |
| | Phosphorus:Alkali Mole Ratio | Infinity | Infinity | Infinity | Infinity |

The examples shown in Table 6 demonstrate the ability to reduce flame retardant in a formula with no added alkali containing catalyst. Formula's 1-4 represent non-alkali containing formulas with reducing amounts of the TEP, non-halogenated, fire retardant. Formulas 1-4 in Table 5 and formulas 1-4 in Table 6 contain equivalent fire retardant loadings respectively, with the only difference being the absence of alkali in the Table 6 formulas. It can be noted that the non-alkali foam maintained its volume under high temperature at fire retardant loadings as low as 1.37% of total foam by weight. It should be noted that the same fire retardant loading in Table 5, which contained alkali metal, was almost completely decomposed.

Examples of Table 7

TABLE 7

| Reagent | Description | 1 | 2 | 3 | 4 | 5 | 6 |
|---|---|---|---|---|---|---|---|
| Stepan PS- | Polyol | 21.31% | 23.41% | 24.73% | 25.60% | 26.64% | 27.81% |
| 2602 | | | | | | | |
| | Nonalkali Trimer | — | — | — | — | — | — |
| | Catalyst 1 | | | | | | |
| | Nonalkali Trimer | — | — | — | — | — | — |
| | Catalyst 2 | | | | | | |
| Pel-ron Pel-cat | Amine Blow Catalyst | 0.14% | 0.14% | 0.14% | 0.14% | 0.14% | 0.14% |
| 9749-A | | | | | | | |
| Pel-ron Pel-cat | Potassium Acetate | 0.27% | 0.27% | 0.27% | 0.27% | 0.27% | 0.27% |
| 9648-A | | | | | | | |
| Pel-ron Pel-cat | Potassium Octoate | 1.36% | 1.36% | 1.36% | 1.36% | 1.36% | 1.36% |
| 9540-A | | | | | | | |
| Albemarle RB- | Halogenated Flame | 7.67% | 5.15% | 3.71% | 2.56% | 1.33% | 0.00% |
| 79 | Retardant | | | | | | |
| Pel-ron Pel-sil | Surfactant | 0.53% | 0.53% | 0.54% | 0.54% | 0.54% | 0.54% |
| P-107 | | | | | | | |
| | WATER | 0.14% | 0.14% | 0.14% | 0.14% | 0.14% | 0.14% |
| | PENTANE | 6.89% | 6.89% | 6.89% | 6.89% | 6.89% | 6.89% |
| Bayer M-489 | Isocyanate | 61.70% | 62.10% | 62.24% | 62.49% | 62.68% | 62.84% |
| | Index | 283 | 283 | 283 | 283 | 283 | 283 |
| | Core Density (pcf) | 1.68 | 1.69 | 1.69 | 1.63 | 1.71 | 1.66 |
| | Muffle Furnace % | 61% | 34% | −15% | −24% | −18% | −86% |
| | Change in Volume | | | | | | |
| | PPM K (by weight) | 1876 | 1876 | 1868 | 1883 | 1883 | 1881 |
| | Moles Potassium/million | 48 | 48 | 48 | 48 | 48 | 48 |
| | grams of foam | | | | | | |
| | PPM Br (by weight) | 34515 | 23175 | 16692 | 11519 | 5993 | 0 |
| | Moles Bromine/million | 432 | 290 | 209 | 144 | 75 | 0 |
| | grams of foam | | | | | | |
| | Bromine:Alkali Weight | 18.5:1 | 12.5:1 | 9:1 | 6:1 | 3:1 | 0 |
| | Ratio | | | | | | |
| | Bromine:Alkali Mole | 9:1 | 6:1 | 4.5:1 | 3:1 | 1.5:1 | 0 |
| | Ratio | | | | | | |

The examples shown in Table 7 demonstrate the inability to reduce flame retardant in a formula with alkali containing catalyst. Formula's 1-6 represent alkali containing formulas with reducing amounts of the RB-79, halogenated, fire retardant. As the fire retardant is reduced from 7.67% to 0%, it can be seen that the high temperature performance of the foam is greatly compromised with the muffle furnace % change in volume going from 61% to −86%, respectively. The foam begins losing volume under high temperature conditions at a 3.71% fire retardant loading.

Examples of Table 8

TABLE 8

| Reagent | Description | 1 | 2 | 3 | 4 |
|---|---|---|---|---|---|
| Stepan PS-2602 | Polyol | 24.89% | 25.86% | 26.86% | 28.01% |
| Airproducts TMR | Nonalkali Trimer Catalyst 1 | 1.62% | 1.62% | 1.62% | 1.62% |
| Pel-ron Pel-cat 9715 | Nonalkali Trimer Catalyst 2 | 0.19% | 0.19% | 0.19% | 0.19% |
| Pel-ron Pel-cat 9749-A | Amine Blow Catalyst | 0.09% | 0.09% | 0.09% | 0.09% |
| | Potassium Acetate | — | — | — | — |
| | Potassium Octoate | — | — | — | — |
| Albemarle RB-79 | Halogenated Flame Retardant | 3.73% | 2.59% | 1.34% | 0.00% |
| Pel-ron Pel-sil P-107 | Surfactant | 0.53% | 0.53% | 0.53% | 0.53% |
| | WATER | 0.14% | 0.14% | 0.14% | 0.14% |
| | PENTANE | 6.89% | 6.89% | 6.89% | 6.89% |
| Bayer M-489 | Isocyanate | 61.93% | 62.10% | 62.33% | 62.52% |
| | Index | 283 | 283 | 283 | 283 |
| | Core Density (pcf) | 1.70 | 1.70 | 1.71 | 1.70 |
| | Muffle Furnace % Change in Volume | 12% | 14% | 13% | −86% |
| | PPM K (by weight) | 0 | 0 | 0 | 0 |
| | Moles Potassium/million grams of foam | 0 | 0 | 0 | 0 |
| | PPM Br (by weight) | 16799 | 11638 | 6043 | 0 |
| | Moles Bromine/million grams of foam | 210 | 146 | 76 | 0 |
| | Bromine:Alkali Weight Ratio | Infinity | Infinity | Infinity | Infinity |
| | Bromine:Alkali Mole Ratio | Infinity | Infinity | Infinity | Infinity |

The examples shown in Table 8 demonstrate the ability to reduce flame retardant in a formula without alkali containing catalyst. Formula's 1-4 represent non-alkali formulas with reducing amounts of the RB-79, halogenated, fire retardant. As the fire retardant is reduced from 3.73% to 0%, it can be seen that the foam continued to intumesce until the flame retardant was absent or below 1.34% of total foam. It will be apparent to those skilled in the art that the embodiments described in the examples may be modified or revised in various ways without departing from the spirit and scope of the presently disclosed technology. All references cited and referred to herein and above are incorporated herein in their entirety.

1. A flame retardant containing polyurethane and/or polyisocyanurate foam composition wherein the molar ratio of flame retardant component to alkali metal and/or alkali earth metal of said foam is greater than 2.5:1, said foam composition comprising less than 1500 ppm (by weigh of total weight of foam) of an alkali metal and/or alkali earth metal, wherein the foamed composition has improved thermal stability as compared to a similar foamed composition with a lower molar ratio of flame retardant component to alkali metal and/or alkali earth metal.

2. The composition of claim 1 wherein the foam composition maintains its volume or intumesces with a loss of no more than 30% in volume as a result of exposure to heat.

3-5. (canceled)

6. The composition of claim 1 wherein the foam composition increases in volume as a result of exposure to heat.

7. The composition of claim 1 wherein the foam composition increases in volume by more than 5% as a result of exposure to heat.

8-12. (canceled)

13. The composition of claim 1 wherein the flame retardant component is at least one of a phosphorus, sulfur and/or halogen and the component is included in the foam as a reactive or non-reactive flame retardant.

14-24. (canceled)

25. The composition of claim 1, said composition comprising less than 1000 ppm (by weigh of total weight of foam) of an alkali metal and/or alkali earth metal.

26-29. (canceled)

30. The composition of claim 1 wherein the flame retardant component is not halogen.

31. The composition of 13 wherein the flame retardant is a reactive flame retardant.

32. The composition of claim 13 wherein the flame retardant is a non-reactive flame retardant.

33. A building material comprising a foamed form of the composition of claim 1.

34. A method producing foam composition of claim 1 comprising combining polyisocyanurate foam composition ingredients with said flame retardant.

35. A flame retardant containing polyisocyanurate foam composition, wherein the improvement comprises less than 1500 ppm (by weight of the total weight of foam) of an alkali metal and/or alkali earth metal.

36. A method of reducing the amount of flame retardant in a flame retardant containing polyurethane and/or polyisocyanurate foam composition without degrading or reducing the thermal stability of said composition under flame conditions, said method comprising including less than 1500 ppm (by weigh of total weight of foam) alkali metal and/or alkali earth metal to the flame retardant containing polyurethane and/or polyisocyanurate foam composition with a reduced the amount of flame retardant component.

37-43. (canceled)
